(19) United States
(12) Patent Application Publication
(10) Pub. No.: US 2021/0287143 A1
(43) Pub. Date: Sep. 16, 2021

(54) UTILIZING SEAT PREFERENCE FOR EVENT TICKETING

(71) Applicant: DISNEY ENTERPRISES, INC., Burbank, CA (US)

(72) Inventor: Michael A. Halleen, Los Angeles, CA (US)

(21) Appl. No.: 16/814,303

(22) Filed: Mar. 10, 2020

(51) Int. Cl. G06Q 10/02; G06Q 50/30; G06F 16/9538; G06F 16/9537; G06F 3/0482

(52) U.S. Cl. CPC G06Q 10/02; G06Q 50/30; G06Q 20/045; G06F 16/9537; G06F 3/0482; G06F 16/9538

(57) ABSTRACT

The present disclosure relates to system and methods for identifying seat or viewing location availability across multiple venues for one or more events. As one example, the method includes receiving venue data from a first venue and a second venue corresponding to a first venue specific layout and a second venue specific layout, respectively; generating a generic seating map based on the venue data, where the generic seating map corresponds to both the first venue and the second venue; associating an event with the generic seating map; and utilizing the seating map to determine availability of a seating location in the generic seating map across the first venue and the second venue.

### TECHNICAL FIELD

The technology described herein relates generally to systems and methods for searching and purchasing tickets, reservations, or the like for events, such as movies, performances, sporting events, etc.

### BACKGROUND

Events, such as movies, performances, sporting events, and other activities typically require a ticket for a particular time/date, a location, and a seat assignment for each participant or attendee. For consumers looking to purchase tickets for such events, they may be required to select the location (venue), date, and time of the event before being presented with options for seat selection. If there are no desirable seats available, the consumer must restart the search, inputting new date, location, and/or time information. Additionally, if a particular location does not have desirable seat options, consumers may have to individually review various alternative venues offering similar events which could be a time consuming and potentially frustrating process.

### SUMMARY

In one embodiment, a method is disclosed that includes receiving first venue data from a first venue corresponding to a first venue specific layout; receiving second venue data from a second venue corresponding to a second venue specific layout; generating a generic seating map based on the first venue data and the second venue data, wherein the generic seating map corresponds to both the first venue and the second venue; associating an event with the generic seating map; and utilizing the generic seating map to determine availability of a seating location in the generic seating map across the first venue and the second venue for the event.

In another embodiment, a method is disclosed that includes transmitting a generic seating map corresponding to two or more venues for an event to a user device; receiving a user selection of a seat area in the generic seating map for the event; determining one or more event times for at least one of the two or more venues with seating availability in the seat area; transmitting a results list based on the seating availability in the seat area to the user device; receiving a user selection for a particular event time at a first venue of the two more venues; and utilizing the user selection to secure a spot for the particular event time at the first venue.

In yet another embodiment, a system for identifying seat availability is disclosed. The system includes a processing element and non-transitory computer readable medium including instructions, that when executed cause the processing element to: receive first venue data corresponding to a first venue, receive second venue data corresponding to a second venue, generate a generic seating map corresponding to the first venue and the second venue based on the first venue data and the second venue data; determine one or more events occurring at the first venue and the second venue; and store the one or more events with the generic seat map to be utilized to identify availability in a location on the generic seat map for the one or more events.

### BRIEF DESCRIPTION OF THE DRAWINGS

FIG. 1 is a perspective system for determining seating or viewing availability for multiple venues for an event.

FIG. 2A is a first seating layout for a first venue with a generic seating map applied thereto.

FIG. 2B is a second seating layout for a second venue with a generic seating map applied thereto.

FIG. 2C is a third seating layout for a third venue with a generic seating map applied thereto.

FIG. 2D illustrates the first seating layout of FIG. 2A with another example of a generic seating map applied thereto.

FIG. 3 is a flow chart illustrating a method of generating a generic seating map, such as the one shown in FIG. 2A.

FIG. 4 is a flow chart of utilizing a generic seating map to reserve tickets for a particular event.

FIG. 5 is a simplified block diagram of a computing device for use with the system.

### DETAILED DESCRIPTION

The present disclosure is related generally to an event availability or reservation system that allows a user to browse or select events based on seat or viewing location. For example, the user can search across multiple dates, times, and venues, for viewing locations in a desired area. Events and activities that can be searched include show times at movie theaters, sporting events, concerts, travel (e.g., airplane seating areas), restaurants, and the like. The system allows users to easily identify availability for a particular event or events in certain seating or viewing areas, without having to first specify location, date, time, venue, etc. This allows a user, who may be flexible on the date/time/location of an event, to easily and quickly determine availability across dates, locations, and times of seats or viewing areas in a preferred location (e.g., middle area centered on the stage or screen).

In one embodiment, the system genericizes or translates seat or viewing locations across different venues into a system specific seating map, such that a user can select a particular viewing location of interest on the system seating map that can be used to determine availability across multiple venues and for multiple events. For example, the system may translate seat locations in a particular venue as falling in a particular sector or zone in the system specific seating map, such that as a user selects a seat in an area of the system specific seat map, the system will search particular seats falling within that area in each venue for availability.

In some embodiments, the generic seating map or system seating map is generated using venue data from two or more venues that host the event or events selected by the user. The generic seating map is a collective representation of the physical maps for each venue that offers the event. The generic seating map may include seat information, as well as focal point and other event characteristics. The venue focal point may be a stage or another area of focus for a particular venue and event.

After a user selects a desired seating location, as well as an event, and optionally other user preferences (e.g., desired dates, locations, distances, etc.), the system will search the various venues for responsive options. The system will then present the responsive options to the user and can either complete the ticketing for a selected option or may direct a user to a third party website or other location to complete the ticketing or reservation process. For example, the system may communicate with the venues and ticketing websites via one or more application programming interfaces (APIs).

Because the ticket locating system identifies viewing locations or seats that meet the user's search criteria from more than one venue simultaneously, the user no longer needs to individually navigate multiple venues while varying preferences such as dates, times, locations, and prices. The system simplifies the user experience by consolidating available seating information into a generic and/or common seating map. Using seat characteristics that pinpoint the location of a seat relative to the venue focal point, retrieved from various ticket selling platforms, the system translates a seating area into the available seats for each venue. Additionally, a number of view elements can be considered such as view angle and focal length ratios with respect to the venue focal point in order to adjust for venues that do not share a similar layout. The ticket locating system of the present disclosure assists the user in interpreting the quality of a seat in venues with different layouts, helping to reduce confusion for users when they are trying to select their seats for various venues.

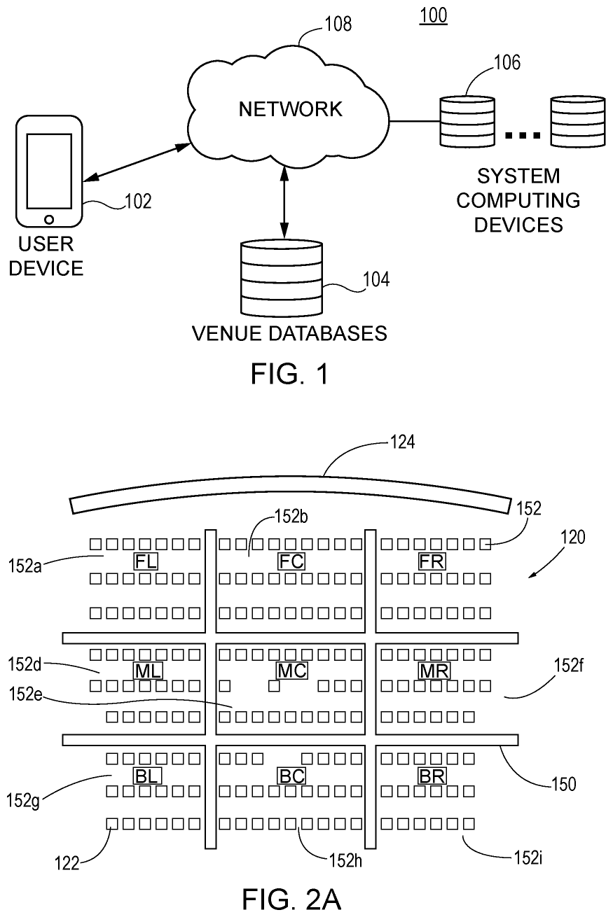

FIG. 1 illustrates a system 100 for determining event and venue availability based on seating or viewing location. The system 100 may include one or more user devices 102, one or more venue databases 104 or computing devices, and one or more system computing devices 106 or servers, all of which may be in direct or indirect communication via a network 108. The system computing devices 106 receive venue information from the venue databases 104 (e.g., theater management databases, ticketing websites, or the like) or may receive the information from a venue directly (e.g., input into the system computing devices 106 such as through a website). Based on the venue specific data, which may include seating layouts, stage or screen locations, and other characteristics, the system computing devices 106 translate venue specific seating or viewing layouts into a generic or system layout. Then, the system computing devices 106 may correlate particular events, show times, and the like, with a venue, and allow a user via the user device 102 to search for available seating locations based on a preferred seat location in the system or generic layout. This allows the system computing devices 106 to search across multiple venues and events, without requiring the user to rerun the search or select a preferred seating area in each individual venue location.

The user device 102 may be any type of computing device and is configured to allow a user to interact with the system 100, such as to input and receive information. The user device 102 may include a smartphone, smart TV, computer, laptop, desktop, gaming device, set top box, tablet, wearable device, or the like.

The system computing devices 106 are substantially any type of computing resource that receives venue information, event information, and user information, and can translate the venue information into system based layout and viewing information, such as generic seating or viewing arrangements, as well as generate research results for event availability in the generic seating maps across the platform based on user input. The system computing devices 106 may also receive information from event planners or managers regarding events, such as in instances where the venue information does not include event information for events hosted at the venue.

The network 108 is substantially any type of communication mechanism or combination of mechanisms, such as the Internet, WiFi, Ethernet, Bluetooth, and radio wave transmission or wired communication protocols. The network 108 allows the various system 100 components (e.g., user devices 102, venue databases 104, and system computing devices 106) to communicate with one another, with other devices, and with modules for each device. For example, select components of the various system components may be hosted on a cloud computing platform, such that the network 108 provides intercommunication for the system computing devices 106 themselves, as well as allows the devices to communicate with others.

The venue databases 104 may be any type of computing resource that may include venue information corresponding to event venues, such as, but not limited to, movie theaters, theaters, stadiums, arenas, sports complexes, airplane layouts, and the like. The event venues may include substantially any type of area where people can reserve or otherwise be assigned seating or viewing locations, such as restaurants, vehicles (e.g., airplanes, buses), concert venues, and the like. The venue databases 104 may also be those tied to or in communication with the venue manager or owner or may be third party databases that include information (either received from the venue manager or owner or from others, such as crowd sourced information) regarding the venue. In some embodiments, the venue databases 104 may be stored as a part of the system computing devices 106 and correspond to sections of a larger venue database within the system computing devices 106 where venue specific information is entered and stored. For example, the system 100 may include an input option, where venue owners, managers, users, or third parties, can enter information about venues into the system computing devices 106 (e.g., via an application, web input, or the like).

Examples of venue information that may be stored in the venue databases 104 includes seating or viewing layout, focal point information, number of viewing areas or levels, perks, or other characteristics for certain seating locations, and other venue characteristics that may be relevant to a user in selecting a particular location for an event (e.g., window position, position relative to exits or restrooms, etc.).

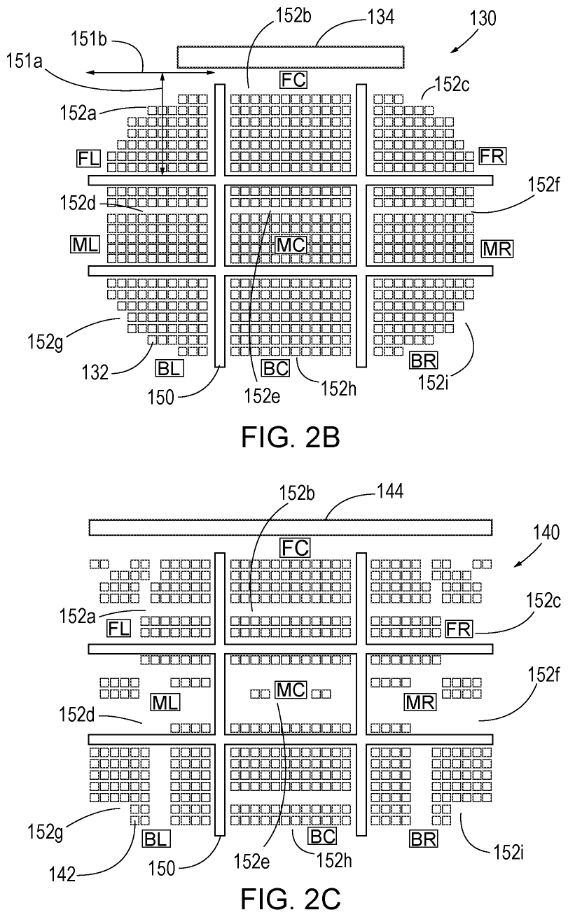

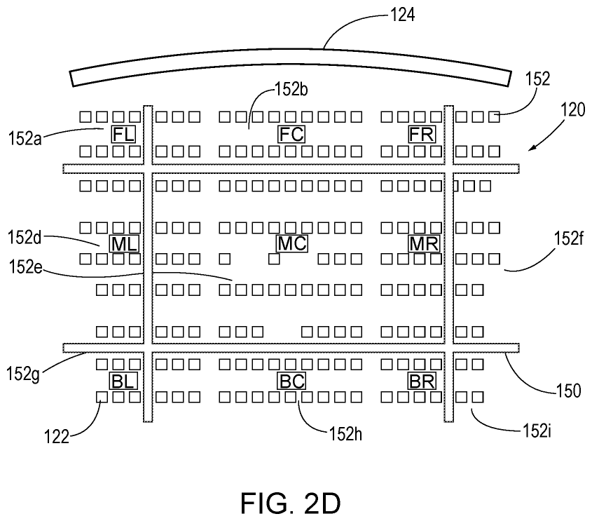

FIGS. 2A-2C illustrate various venue seating layouts 120, 130, 140 with a generic seating map 150 having nine seating areas or zones 152a, 152b, 152c, 152d, 152e, 152f, 152g, 152h, 152i, overlaid on the venue maps. With reference to FIG. 2A, a first venue seating layout 120 includes seats 122. When the first venue seating layout 120 is translated to the generic seating map 150, sections of the seats 122 are grouped into a particular generic zone, e.g., approximately three rows of seats 122 having varying numbers of seats per row are captured in each of the seating areas 152a, 152b, 152c, 152d, 152e, 152f, 152g, 152h, 152i. Select seats 122 falling into a particular seating area may be determined based on the distance relative to the focal point 124 (e.g., movie screen or stage), as well as the angle of the seat relative to the focal point, or the like. As can be understood, in some instances, the generic seating map 150 may be a mapping or zone division that assigns or otherwise captures select seats of the venue into a particular generic zone or bucket (e.g., front center FC, middle center MC, back center BC, front left FL, middle left ML, back left BL, front right FR, middle right MR, back right BR). In this manner, the generic seating map 150 may be a grid overlaid onto seating maps of venues, where the number of zones is variable (e.g., more or less granular) as desired and the shape of the zones is also variable with some zones being larger than other zones and/or shaped differently than other zones. For example, FIG. 2D, illustrates a different generic seating zone applied to the venue seating layout 120. As shown in FIG. 2D, the center middle seating zone 152e is increased in size as compared to the other zones, such that a majority of the seats 122 for the venue layout 120 will fall within the center middle zone 152e.

With reference to FIG. 2B, in this example, the second venue seating layout 130 may be a larger venue than the first venue in FIG. 2A and include more seats 132 within each of the generic seating areas 152a, 152b, 152c, 152d, 152e, 152f, 152g, 152h, 152i, since the venue is larger with increased seating capacity, where the selection of seats falling within a particular seating area is based on a ratio of seats relative to the total number of seats and a distance ratio relative to the focal point 134. Finally, in a third venue seating layout 140 shown in FIG. 2C having a focal point 144, the seats 142 falling into the selected seating areas 152a, 152b, 152c, 152d, 152e, 152f, 152g, 152h, 152i is variable, with certain areas being more densely populated than others, since the assignment of a particular seat to a generic seating, may be based on the location relative to the focal point 144 or venue viewing boundaries, rather by number of seats 142.

As can be understood, the generic seating map 150 or generic layout corresponds to multiple venues, including venue layouts 120, 130, and 140. The generic layout 150 may include any number of seating locations, but in this example includes nine seating areas 152a, 152b, 152c, 152d, 152e, 152f, 152g, 152h, 152i where seats in the various venue specific layouts are organized or translated to fall within one of these generic seating areas 152a, 152b, 152c, 152d, 152e, 152f, 152g, 152h, 152i. Although, in other examples, fewer or more generic seating areas or zones may be included, depending on user preferences. In one example, each generic seating area may correspond to a particular distance ratio from the focal point of the venue to the bounds of the seating area. As a specific example, as shown in FIG. 2B, the seating area 152a is defined as having a boundary starting at 0% from the distance of the focal point to a backmost row and extending to 33% of the distance from the focal point to the backmost row, illustrated as arrow 151a and extending from a outermost row inwards to 25% of the distance from the outer most row towards the center (illustrated as arrow 151b). In this manner, the seating areas 152a, 152b, 152c, 152d, 152e, 152f, 152g, 152h, 152i may not correspond to the seating areas in the venue specific layouts, as certain seats may fall into a first seating area that fall into other seating areas in the venue specific layouts.

As another example (that may be used with the distance percentage or separate therefrom), the generic seating areas 152a, 152b, 152c, 152d, 152e, 152f, 152g, 152h, 152i may be determined based on an angle of the venue seats relative to a venue focal point as compared to an angle of a generic seat relative to a generic focal point. As yet another example, the venue seats may be correlated to the generic seating areas based on seat number ratios, e.g., the seats per row has a value of X and the venue has a total number of rows as a value Y, in instances where there may be nine generic seating areas (e.g., front center, middle center, back center, front left, middle left, back left, front right, middle right, back right), X divided by 3 defines the left, right, and center seating areas and Y divided by 3 defines the front, middle, and back seating areas.

In instances where the ratio of the height of the focal point (e.g., height of screen) relative to the number of rows exceeds a predetermined threshold, then certain seating areas (such as the front center FC and front right FR seating areas) may be designed to guarantee that these seating areas are at least within a maximum distance from the screen or focal point. For example, for a 20 foot high screen room in a venue with 150 seats, the front center may be capped at a distance of 10 feet from the screen to ensure that it maximizes the distance to the screen. In such instances, the zones furthest from the focal point (e.g., the back seating areas) might have additional seats falling into the generic zones, as compared to other venues.

The types of translations that may be applied to the venue specific seating layouts 120, 130, 140 may vary as desired in order to assign specific seats for a venue to a location in the generic seating areas 152a, 152b, 152c, 152d, 152e, 152f, 152g, 152h, 152i. For example, the translations may define the generic seating areas 152a, 152b, 152c, 152d, 152e, 152f, 152g, 152h, 152i or seating zones as being defined within certain percentage or ratio boundaries relative to the focal point and venue boundaries, may define the seating areas as a percentage of number of seats based on a defined front and back rows of seats and right and left columns of seats. As another example, the translations may determine the seats based on a pure distance calculation to the focal point (e.g., X feet back from the focal point and Y feet from the center axis of the focal point). Other types of translations may be used as well depending on the venue structure, seat characteristic, slope or angle of the seats relative to a focal point, events, and the like. It should be noted that the number of generic seating areas for the generic seating map may vary as desired and can be more or less granular depending on user preferences. As such, the example of the generic seating areas shown in FIGS. 2A-2C is meant as illustrative only.

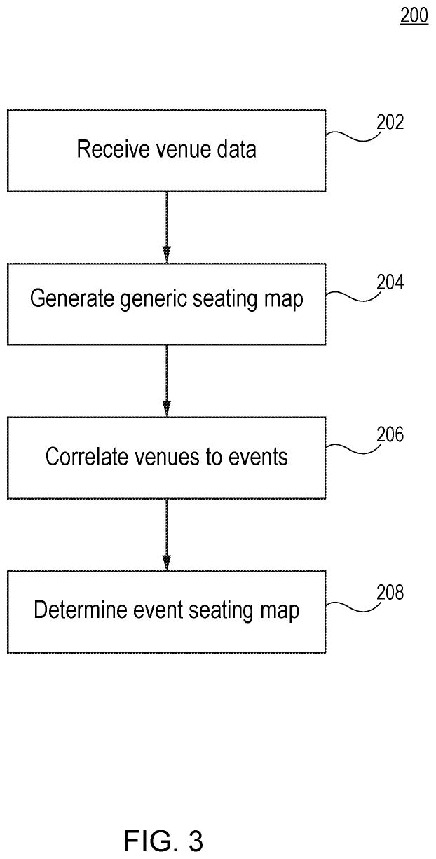

FIG. 3 illustrates a method 200 for generating generic seating maps for specific events, e.g., movies, concerts, etc. The method 200 may begin with operation 202 in which the system computing devices 106 (e.g., processing elements), receive venue data for relevant venues. For example, the venue data may be provided directly to the system computing devices 106 by users (e.g., venue owners that input to the data into the system). As another example, the venue data may be retrieved from the venue databases 104, such as ticketing websites, venue websites, or the like. The venue data may include the seating layout for the particular venue, including seating areas, seat characteristics, as well as venue location, venue features, venue type (e.g., theater, arena, airplane, restaurant), and other information that may be relevant to a user when selecting a particular venue for an event. In some embodiments, the venue data is retrieved for two or more venues (e.g., first venue data from a first venue corresponding to a first venue specific layout and second venue data from a second venue corresponding to a second venue specific layout), and in many instances, for multiple venues in multiple locations.

In operation 204, the method 200 generates a generic seating map 150 for two or more venues, i.e., one generic seating map 150 will be generated that encompasses two or more venues. The generic seating map 150 may be generated for a subset of venues, e.g., all venues within a particular city, venues within a particular city hosting a particular event (e.g., movie theaters screening a particular movie, theaters screening a particular show, stadiums hosting a particular sport, etc.), or the like. Alternatively, the generic seating map 150 may be generated for all venues for which venue data has been received. In some instances, as new venue specific seating layouts are provided to the system 100, the system may analyze those seating layouts to assign seats within each venue specific layout to a generic seating zone in the generic seating map 150.

In operation 206, the method 200 correlates particular venues (and the generic seating map generated for those particular venues in operation 204) to specific events. For example, a database may be generated or entries may be entered into a database, that indicates events being presented (e.g., movies, concerts, sporting events, etc.) on particular times and dates at select venues. This database or lookup table or other structure can then be used during searching functions to determine availability in a particular generic seating area for a select event. The system 100 may determine event information from event organizers, venue websites or the venue databases 104, or in other manners. In this operation, the database stored in the system 100 devices may include data indicating availability in certain generic seating areas 152a, 152b, 152c, 152d, 152e, 152f, 152g, 152h, 152i for events, which could be further filtered by venue location, venue type, and other types of venue information received in operation 202.

In operation 208, the method 200 determines an event seating map for the various venues. For example, in some instances, the venue may be specially arranged based on the type of event or equipment used in a particular type of event, e.g., at a stadium certain concerts have 360 degree stages whereas others have stages with only 180 degrees or less viewable area. In the latter example, the venue seating map (and thus the generic seating map for that event) would need to be updated to omit the seats that would not be available for a user to purchase as they are blocked. In many instances, the event specific seating map would be specific to the event (e.g., Band X Tour), but be applied generically to multiple venues, e.g., all stadiums hosting Band X. Alternatively, the events may be categorized, such as “concert on one end,” “middle stage,” or the like, which is used to select a particular set of seats in the venue specific seating areas available to be used. In many instances, the event seating map for the various venues may be stored in an event and seating database that can be utilized by the system 100 when determining availability for a particular event.

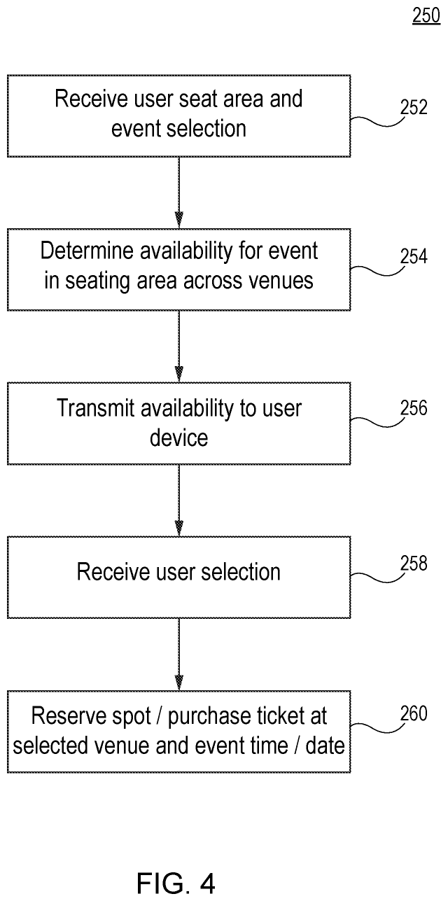

FIG. 4 illustrates a method 250 for reserving or purchasing event tickets or spots based on seating preference. In operation 252, the method 250 includes receiving a user seat area and event selection. For example, the system 100 may present an event selection option on the user device 102, which the user can utilize to select a particular event (e.g., movie, concert, sporting team, etc.). Based on the event selection, the system 100 will reference the event and seating maps, such as the ones generated in operation 208 (and optionally stored in an event database), to determine the event generic seating map, as well as determine relevant venues that are presenting the particular event. For example, the system 100 can retrieve the list of venues that are screening a particular movie, determine venues hosting a particular sports team for sporting events, airplanes that are flying to a particular location, or the like.

Operation 252 may also include receiving a user selection for a preferred seating area, such as one of the areas on the generic seating map 150. For example, the system 100 may transmit the generic seating map 150, which may include an optional generic focal point and/or description of the seating areas, to the user device 102. The user may then use the generic seat map 150 and/or descriptions to select a particular generic seating area 152a, 152b, 152c, 152d, 152e, 152f, 152g, 152h, 152i that she or he would prefer to view the event from. In some instances, the user may select a predetermined seating area (e.g., one provided by the system 100) and in other instances the user may generate his or her own seating area. For example, the user may draw or otherwise select areas on the generic seating map 150, such drawing a shape (e.g., circle) on the seating map display that captures a selection of seats, or otherwise provide a dynamic selection of seating areas based on the generic seating map 150. Additionally or alternatively, the user may input certain seat characteristics, e.g., padded, adjacent to a railing, extra wide, on an aisle, adjacent an exit, handicap sections, venue brand, multiple seats adjacent one another, near a window, etc., which can be used as additional search requirements during the availability query.

Using the generic seat selection (and any user specific preferences), as well as the event information, the method 250 proceeds to operation 254 and the system 100 determines availability for the event in the desired seating areas with any user specific preferences across two or more venues. For example, the system 100 may query the generic maps generated with method 200 (e.g., by querying a database of the generic maps and events) to determine availability in selected venues in the seating areas corresponding to the generic seating area selected by the user for the particular event. As one example, the user may search for two seats in generic seating area 152a for Event A (e.g., movie screening of movie A), and include user preferences, such as maximum distance from user's location, preferred dates/times, seat type, venue type, etc. The system 100 then queries the database for venues with availability matching the specifics of the query, e.g., those venues with seating falling within in generic seating area 152a, screening the movie A, and satisfying any other user preferences.

The method 250 then proceeds to operation 256 in which the results are transmitted to the user device 102. For example, the system 100 may prepare a results listing including all venues that satisfy the requirement. The results list may be filtered or ordered as desired, e.g., may be ordered to present the options in terms of event times/dates, venue location, most relevant, closest venue based on distance, number of seats, pricing, or any other type of filtering characteristic or optional user preference.

In operation 258, the system 100 receives a user selection for a particular venue, event, time, and date. For example, the user may input a selection on the user device 102 indicating which of the displayed results the user may wish to pursue, such as by highlight, selecting, or otherwise indicating one of the results.

In operation 260, the method 250 reserves/purchases one or more selected spots, seats, or other area, for the user at the selected venue, event, time, and date. For example, the system 100 may provide the desired user selections to a third party website (e.g., venue website, ticketing website, or the like), which allows the user to complete the transaction and purchase the desired event tickets. In other examples, the system 100 may communicate directly with the venues and may allow a user to directly purchase (or otherwise secure) the desired seats within the system 100 environment, such as a web browser, application, or the like.

Utilizing the methods 200, 250 a user may be able to search across multiple venues playing a particular movie (as an example) having seats available in the preferred seating area. In this manner, the user does not have to search each venue, movie screening time, and movie screening date, individually, but can determine applicable availability across a single search. This allows users who may prefer a seat location over venue location, time, date, etc., to easily identify and purchase tickets. As another example, the methods 200, 250 allow users that may have flexibility in time and dates for flying from a first location to a second location to search for available seats based on a preferred seating area of the airplane, e.g., exit row, window seat, first class, middle of the plane, etc. Rather than having to search each flight, airline, date, and time individually for results that may happen to have availability in the desired area, in this example the event schedules may be flight schedules to/from particular cities or destinations. As yet another example, a user who enjoys viewing a sports team, but perhaps only from the club level on the first base side of the stadium, to conduct a search by seat location, rather than matchup, date, or time, e.g., the system will search all home games for a baseball team with availability in the desired seating area, rather than the user having to search for availability for each game separately.

As can be understood, although the term venue is used, this term is meant to encompass all types of seating or viewing areas for any type of event, such as, but not limited to, movies, airplane flights, restaurant reservations, sporting events, and the like. As such, while the term venue may encompass buildings, such as theaters, arenas, and restaurants, it may also encompass other structures, such as vehicles, airplanes, and the like. Similarly, although the terms seat and seating area have been used, these terms are meant to encompass all types of locations in a venue that may be reserved or purchased, such as standing locations, picnic areas, very important person (VIP) areas, or the like.

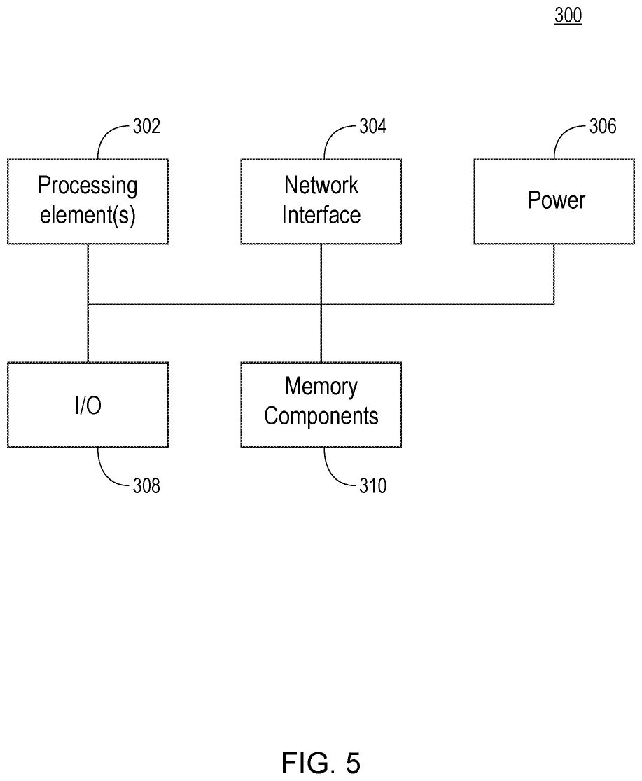

The system 100 and methods 200, 250 may be executed by various computing components in communication with one another. FIG. 5 illustrates a simplified block diagram of a computing device that may be used as any of the components of the system 100 and to execute the methods 200, 250. For example, various operations in the methods 200, 250 may be performed by one or more processors or processing elements as they execute instructions, such as those stored on memory components of the like.

With reference to FIG. 5, a computing device 300 may include one or more processing elements 302, a network interface 304, a power supply 306, an input/output interface 308 or other user output/input device, and one or more memory components 310, all of which may be in direct or indirect communication with one another, such as via one or more system busses, wire traces, wireless communication methods, or the like.

The one or more processing elements 302 may be substantially any electronic device capable of processing, receiving, and/or transmitting instructions. For example, the processing element 302 may be a microprocessor, microcomputer, graphics processing unit, or the like. It also should be noted that the processing element 302 may include one or more processing elements or modules that may or may not be in communication with one another. For example, a first processing element may control a first set of components of the computing device 300 and a second processing element may control a second set of components of the computing device 300 where the first and second processing elements may or may not be in communication with each other. Relatedly, the processing elements may be configured to execute one or more instructions in parallel, locally, and/or across the network, such as through cloud computing resources.

The memory components 310 may be a computer readable medium operable to store electronic data that may be utilized by the computer 300, such as audio files, video files, document files, programming instructions, venue database information, seating databases, and the like, and which may be non-transitory. The memory components 310 may be, for example, non-volatile storage, a magnetic storage medium, optical storage medium, magneto-optical storage medium, read only memory, random access memory, erasable programmable memory, flash memory, or a combination of one or more types of memory components.

The network interface 304 receives and transmits data to and from a network 108 to the various devices in the system 100. The network interface 304 may transmit and send data to the network directly or indirectly. For example, the network interface 304 may transmit data to and from other computing devices through a network which may be a cellular, satellite, or other wireless network (Wi-Fi, WiMAX, Bluetooth) or a wired network (Ethernet), or a combination thereof. In some embodiments, the network interface 304 may also include various modules, such as an API that interfaces and translates requests across the network to other elements of the system 100.

The power supply 306 provides power to various components of the computing device 300. The power supply 306 may include one or more rechargeable, disposable, or hardwire sources, e.g., batteries, power cord, AC/DC inverter, DC/DC converter, or the like. Additionally, the power supply 306 may include one or more types of connectors or components that provide different types of power to the computing device 300. In some embodiments, the power supply 306 may include a connector (such as a universal serial bus) that provides power to the computer or batteries within the computer and also transmits data to and from the device to other devices.

The input/output (“I/O”) interface 308 allows the computing device 300 to receive input from a user and provide output to the user. For example, the input/output interface 308 may include a capacitive touch screen, keyboard, mouse, pedal, stylus, hotkey, button, joystick, or the like. The type of devices that interact via the input/output interface 306 may be varied as desired.

The above specifications, examples, and data provide a complete description of the structure and use of exemplary examples of the invention as defined in the claims. Although various examples of the disclosure have been described above with a certain degree of particularity, or with reference to one or more individual examples, those skilled in the art could make numerous alterations to the disclosed examples without departing from the spirit or scope of the claimed invention. Other examples are therefore contemplated. It is intended that all matter contained in the above description and shown in the accompanying drawings shall be interpreted as only illustrative of particular examples and not limiting. Changes in detail or structure may be made without departing from the basic elements of the invention as defined in the following claims. Additionally, the various components any features described with reference to any particular embodiment may be shared across multiple embodiments as desired.

1. A method comprising:
receiving first venue data from a first venue corresponding to a first venue specific layout;
receiving second venue data from a second venue corresponding to a second venue specific layout;
generating a generic seating map based on the first venue data and the second venue data, wherein the generic seating map corresponds to both the first venue and the second venue;
associating an event with the generic seating map; and
utilizing the generic seating map to determine availability of a seating location in the generic seating map across the first venue and the second venue for the event.

2. The method of claim 1, further comprising receiving a user selection for the seating location in the generic seating map for the event.

3. The method of claim 2, further comprising determining that at least one of the first venue or the second venue has available seats in a venue location corresponding to the seating location in the generic seating map for the event.

4. The method of claim 3, further comprising transmitting to a user device a results list including at least one of an event time or an event date at either the first venue or the second venue with available seats in the venue location corresponding to the seating location.

5. The method of claim 1, wherein the event is one of: a movie screening, a sporting event, a performance, a play, an airline flight, or a concert.

6. The method of claim 1, wherein generating the generic seating map comprises:
translating a first seat within the first venue specific layout to a seat location in the generic seating map; and
translating a second seat within the second venue specific layout into the seat location in the generic seating map.

7. The method of claim 6, wherein the translation of the first seat within the first venue is based on a distance ratio of the first seat relative to a first focal point in the first venue specific layout.

8. The method of claim 7, wherein the distance ratio is compared to a generic distance ratio from the seat location in the generic seating map to a generic focal point in the generic seating map.

9. A method comprising:
transmitting a generic seating map corresponding to two or more venues for an event to a user device;
receiving a user selection of a seat area in the generic seating map for the event;
determining one or more event times for at least one of the two or more venues with seating availability in the seat area;
transmitting a results list based on the seating availability in the seat area to the user device;
receiving a user selection for a particular event time at a first venue of the two or more venues; and
utilizing the user selection to secure a spot for the particular event time at the first venue.

10. The method of claim 9, further comprising generating the generic seating map by translating a plurality of seat locations in the first venue into generic seating locations in the generic seating map and translating a plurality of seat locations in the second venue into the generic seating locations in the generic seating map.

11. The method of claim 10, wherein the translation of the plurality of seat locations in the first venue is based in part on a distance of the plurality of seating locations to a first venue focal point and a distance of the generic seating locations to a generic focal point.

12. The method of claim 10, wherein the translation is dependent on the event, such that for a first event, the plurality of seat locations in the first venue correspond to a first set of generic seating locations in the generic seating map and for a second event, the plurality of seat locations in the first venue correspond to a second set of generic seating locations in the generic seat map.

13. The method of claim 9, wherein the user selection is based on predetermined seat areas within the generic seat map.

14. The method of claim 9, wherein the user selection is based on dynamic seat areas determined by the user within the generic seat map.

15. The method of claim 9, further comprising analyzing the seating availability in the seat area for the one or more event times based on one or more additional preferences.

16. The method of claim 15, wherein the one or more additional preferences includes at least one of: a venue location relative to a user device location, a venue type, or a seat type.

17. A system for identifying seat availability comprising:
a processing element;
a non-transitory computer readable medium comprising instructions that when executed cause the processing element to:
receive first venue data corresponding to a first venue;
receive second venue data corresponding to a second venue;
generate a generic seating map corresponding to the first venue and the second venue based on the first venue data and the second venue data;
determine one or more events occurring at the first venue and the second venue;
store the one or more events with the generic seat map to be utilized to identify availability in a location on the generic seat map for the one or more events.

18. The system of claim 17, wherein the instructions further cause the processing element to:
output to a user device identified availability in the location on the generic seat map for the one or more events; and
based on a user selection of the identified availability, reserve a ticket for an event corresponding to the availability in the location on the generic seating map.

19. The system of claim 17, wherein generating the generic seat map further comprises identifying a first set of seats in the first venue that correspond to a first generic zone in the generic seat map and identifying a second set of seats in the second venue that correspond to the first generic zone in the generic seat map.

20. The system of claim 17, wherein the one or more events comprise an airline flight schedule from a first location to a second location, the first venue is a first airplane, and the second venue is a second airplane.
